(19) United States
(12) Patent Application Publication
(10) Pub. No.: US 2006/0132076 A1
(43) Pub. Date: Jun. 22, 2006

(54) Method for automatically adjusting the commutation angle in brushless direct current motors

(76) Inventors: Michael Finsinger, Augsburg (DE); Nicolay Berbatov, Villingen-Schwenningen (DE)

Correspondence Address: NORMAN H. ZIVIN;Cooper & Dunham LLP, 1185 Avenue of the Americas, New York, NY, 10036, US

(21) Appl. No.: 11/261,322

(22) Filed: Oct. 28, 2005

(30) Foreign Application Priority Data
Nov. 11, 2004 (DE) 10 2004 054 504.9

(51) Int. Cl. H02P 25/12

(52) U.S. Cl. 318/439

(57) ABSTRACT

The invention relates to a method and a device for automatically adjusting the commutation angle α of a brushless electric motor, the electric motor being driven by an electronic motor controller based on an open loop control and using a variable commutation angle α. According to the invention, the following steps are performed repeatedly: Measuring the actual rotational speed ω of the electric motor;
Comparing the actual rotational speed with a previously ascertained and stored rotational speed ω^{α}_{old},
Increasing the commutation angle α by a given value Δα, should ω>ω^{α}_{old}; or
Decreasing the commutation angle α by a given value Δα, should ω<ω^{α}_{old}; and
Storing the actual number of rotations ω as a new value ω^{α}_{old}.

The invention relates to a method for automatically adjusting the commutation angle in brushless DC motors according to the preamble of patent claim 1.

Brushless DC motors (BLDC motors) are used in a large variety of different applications, for example, in fans, electric tools as well as in automotive applications. Here, the motor is directly connected to a DC power source with motor electronics or a motor controller being used to drive the motor. In modern BLDC motors, a microcontroller, which allows the greatest possible flexibility in every application, is employed as the heart of the control electronics. The use of a microcontroller makes it possible to adjust the commutation angle relatively easily so as to achieve maximum motor efficiency in every application.

The commutation angle of a motor is the angle between current commutation in the windings of the motor and the magnetically neutral phase of the stator. If the commutation angle is too large, the motor has a braking phase before commutation. A commutation angle that is too small results in only a slight increase in current (dI/dt) in the motor winding due to the low reluctance torque (back EMF). The optimal commutation angle also depends on the number of revolutions (rotational speed) of the motor. The higher the rotational speed, the greater the commutation angle may be.

The optimum flow of current in the motor winding to achieve the highest motor efficiency depends greatly on the following parameters:

| | |
|---|---|
| Commutation angle | α |
| Operating voltage | Uᵢₙ |
| Rotational speed | ω |
| Motor load and design | L, Rₛ, n |
| Capacity of the storage capacitor | C |

The operating voltage Uᵢₙ, the capacity of the storage capacitor C, the rotational speed ω and the motor load are either given parameters or cannot be changed during the operation of the motor in order to achieve an optimum flow of current in the motor windings. The commutation angle can be changed by firmware and has a great influence on the flow of current in the motor winding and consequently on the efficiency of the motor.

The optimal commutation angle is calculated on the basis of a complicated equation which depends on various parameters, as can be seen in Equation (1):
αₒₚₜ=f(Uᵢₙ,C,ω,L,n_{winding},L_{winding},R_{winding},T_{magnet}, . . . ) (1)

It is very difficult to put this equation into practice which means that the commutation angle is mostly adjusted according to a set value which represents a compromise between the operational conditions of the motor.

The object of the invention is to provide a method for automatically adjusting the commutation angle in a brushless electric motor in order to improve the efficiency of the motor as a function of the number of revolutions.

This object has been achieved by a method having the characteristics outlined in claim 1. An appropriate device to carry out the method is defined in claim 6.

Further preferred embodiments and features of the invention can be derived from the subordinate claims.

The method described, which is preferably implemented in the firmware of the microcontroller of the motor controller, regulates the commutation angle automatically as a function of the actual rotational speed, in order to improve the efficiency of a BLDC motor in an open loop control.

The method changes the commutation angle α such that for a given rotational speed ω, improved motor efficiency is achieved. The commutation angle can be changed in a specific range, a lower limiting value αₘᵢₙ and an upper limiting value αₘₐₓ preferably being given. A specific commutation angle α, such as the mean value between αₘᵢₙ and αₘₐₓ, is used as the starting value. The method starts as soon as the motor reaches a steady operating state. This happens when the motor controller does not receive a control signal to change the rotational speed, and the rotational speed has adjusted to a given value. Using the method according to the invention, the commutation angle α can now be optimized as follows.

The actual rotational speed ca is measured and compared to a rotational speed ω^{α}_{old} that has been stored before the last changes in the commutation angle α. When the motor is restarted, ω^{α}_{old} is set to zero and α is set to a value between αₘᵢₙ and αₘₐₓ.

If the actual rotational speed ω is greater than the previously stored rotational speed ω^{α}_{old}, this means that the motor efficiency has improved since the last change in the commutation angle since the other motor parameters have remain unchanged. To possibly improve the efficiency by even more, the commutation angle is made larger in that a given value Δα is added on to the actual commutation angle α.

However, should the actual rotational speed ω be smaller than the previously stored rotational speed ω^{α}_{old}, this means that the motor efficiency has declined. The commutation angle is made smaller in that a given value Δα is subtracted from the actual commutation angle α.

Before each change in the commutation angle α, the actual rotational speed is stored as a value ω^{α}_{old}. After a change in the commutation angle, there is again a delay until a stable operating state with a stable rotational speed has been established. The actual rotational speed is then newly measured and the method performed from the beginning.

The method operates continually in the background of the motor controller.

The advantage of the method according to the invention is that the motor controller does not require any sensors to measure the motor voltage and the motor current in order to determine the performance of the motor. In applications having a highly variable operating voltage, provision can be made for the operating voltage to be measured. The method is implemented as firmware in the motor controller. This means that the method can be particularly used in low-cost applications and also in applications that only allow for small-scale motor electronics/sensors.

A preferred embodiment of the invention is now described on the basis of the drawing.

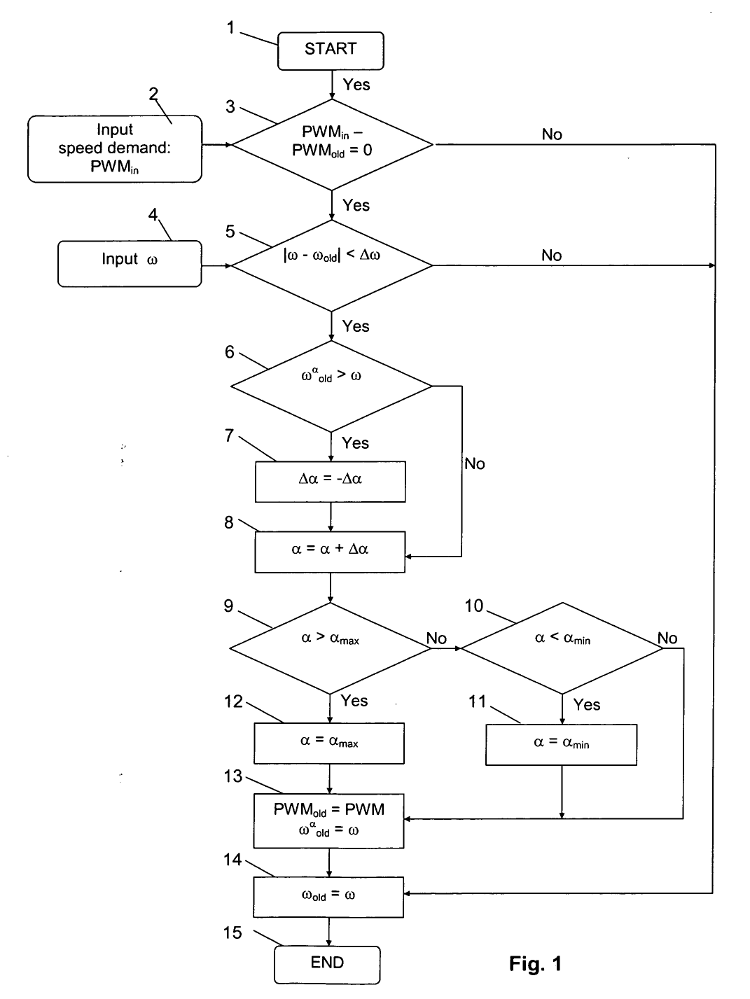

FIG. 1 shows a flowchart of the procedure according to the invention to adjust the commutation angle.

After the method has been started according to Step 1, a check is first made to determine whether the speed setting for the motor has changed (Step 2). As a rule, a brushless DC motor is driven by pulse width modulation. By specifying the pulse-duty factor PWMᵢₙ, the rotational speed or the number of revolutions of the motor can be determined. A check is made in Step 3 to determine whether the given pulse-duty factor has changed by subtracting the value of a previously stored pulse-duty factor PWM_{old} from the value of the actual pulse-duty factor PWMᵢₙ, and it is verified whether the difference is zero. If the difference is not zero, this means that the speed specification has been changed which results in a change in rotational speed ω which means that the motor state is temporarily unstable. This means that the commutation angle α cannot be adjusted at that point in time so that the method continues with Step 14. In Step 14 the actual rotational speed co is stored as value ω_{old}.

If it is found in Step 3 that the speed specification has not changed, i.e. the difference between PWMᵢₙ and PWM_{old}=Zero, the actual rotational speed ω is then measured in the next Step 4. In Step 5 the value of the actual rotational speed ω is then subtracted from the stored value ω_{old} and the absolute value results from this difference. This absolute value is compared to a value Δω. If this absolute value is not less than a given value Δω, this means that the rotational speed ω is still changing relatively strongly and the motor has not yet reached its steady operating status. The procedure thus continues with Step 14 and the actual value of the rotational speed ω is stored as value ω_{old}.

However, if the absolute value from Step 5 is smaller than a certain reference value Δω, this means that the rotational speed ω is not changing very much any more and the motor has reached its steady operating state. In this event, a start can be made to adjust the commutation angle α. To this effect, the procedure continues with Step 6. In Step 6 the actual rotational speed α is compared to a value cold based on the commutation angle. ω^{α}_{old} represents the rotational speed at which the last change in the commutation angle α was measured if the rotational speed ω is greater than the value ω^{α}_{old}, this means there has been an improvement in motor efficiency since the last change in the commutation angle α. In this case, a specific value Δα is added to the actual commutation angle α, i.e. the actual commutation angle α is increased (Step 8). If, however, ω^{α}_{old} is greater than c, the efficiency of the motor has declined and the procedure is continued with Step 7 and the value Δα is set to the value −Δα. This means that in Step 8 a negative value Δα is added to the actual commutation angle thus reducing the commutation angle α in this case.

The range within which the change in the commutation angle α can move is determined in the motor controller. To this effect, a lower range limit αₘᵢₙ and an upper range limit αₘₐₓ are set. A check is made in Step 9 to determine whether the actual commutation angle α is greater than the maximum value αₘₐₓ. If this is the case, in Step 12 the value of the actual commutation angle α is set at the maximum value αₘₐₓ. If this is not the case, the procedure continues with Step 10. Here, it is verified whether the actual commutation angle α is smaller than the minimum value αₘᵢₙ. If this is the case, in Step 11 the actual commutation angle α is set at the value αₘᵢₙ. If this is not the case, the procedure is continued with Step 13. In this step, the actual pulse-duty factor PWM is stored in the value PWM_{old}. At the same time, the value ω^{α}_{old} is set at the actual value ω of the rotational speed. In Step 14, the actual value ω of the rotational speed is stored in the value ω_{old}. The method is now ended (Step 15). It can be performed again from the beginning.

### LIST OF PARAMETERS USED

ω Actual rotational speed (number of revolutions)
Δω Allowed deviation from the rotational speed
ω^{α}_{old} Rotational speed at the last change in the commutation angle α
ω_{old} Last stored value of the rotational speed
α Actual commutation angle
Δα Value of change in the commutation angle
αₘₐₓ Maximum permitted commutation angle
αₘᵢₙ Minimum permitted commutation angle
PWMᵢₙ Given pulse-duty factor
PWM_{old} Previous pulse-duty factor

1. A method for automatically adjusting the commutation angle α of a brushless electric motor, the electric motor being driven by an electronic motor controller based on an open loop control and using a variable commutation angle α,
characterized in that
the following steps are performed repeatedly:
Measuring the actual rotational speed ω of the electric motor;
Comparing the actual rotational speed with a previously ascertained and stored rotational speed ω^{α}_{old},
Increasing the commutation angle α by a given value Δα,
should ω>ω^{α}_{old}; or
Decreasing the commutation angle α by a given value Δα,
should ω>α^{α}_{old}; and
Storing the actual number of rotations ω a new value ω^{α}_{old}.

2. A method according to claim 1, characterized in that the commutation angle α is variable between a lower limiting value αₘᵢₙ and an upper limiting value αₘₐₓ.

3. A method according to claim 1, characterized in that a change in the commutation angle is only made when the motor has a stable operating status.

4. A method according to claim 1, characterized in that the motor efficiency is optimized without having to measure the input power, i.e. the actual voltage and the input current.

5. A method according to claim 1, characterized in that the method is used in a motor to drive fans or pumps.

6. A device to adjust the commutation angle in a brushless electric motor, as part of an electronic motor controller based on an open loop control to drive the electric motor having a variable commutation angle α,
characterized by:
Means of measuring the actual rotational speed ω of the electric motor;
Means of comparing the actual rotational speed with a previously ascertained and stored rotational speed ω^{α}_{old},
Means of changing the commutation angle α, the commutation angle α being increased by a given value Δα, should ω>ω^{α}_{old}, or decreased by a given value Δα, should ω<ω^{α}_{old};
Means of storing the rotational speed ω^{α}_{old}.

7. A device according to claim 6, characterized in that the means of measuring the actual rotational speed comprises at least a Hall sensor whose output signals are evaluated by the motor controller.
